(19) United States
(12) Patent Application Publication
(10) Pub. No.: US 2015/0263900 A1
(43) Pub. Date: Sep. 17, 2015

(54) HIGH PERFORMANCE DISTRIBUTED COMPUTING ENVIRONMENT PARTICULARLY SUITED FOR RESERVOIR MODELING AND SIMULATION

(71) Applicant: SCHLUMBERGER TECHNOLOGY CORPORATION, SUGAR LAND, TX (US)

(72) Inventors: VALERY POLYAKOV, BROOKLINE, MA (US); RAYMOND KOCIAN, OSPREY, FL (US); DZEVAT OMERAGIC, LEXINGTON, MA (US); TAREK M. HABASHY, BURLINGTON, MA (US)

(73) Assignee: SCHLUMBERGER TECHNOLOGY CORPORATION, SUGAR LAND, TX (US)

(21) Appl. No.: 14/204,584

(22) Filed: Mar. 11, 2014

(51) Int. Cl. H04L 12/24; G06Q 50/06; H04L 29/08; H04L 12/58

(52) U.S. Cl. CPC H04L 41/0836; H04L 41/0266; H04L 51/066; G06Q 50/06; H04L 67/12

(57) ABSTRACT

A distributed computing system and method is described herein. The system and method employ a server node, compute nodes, a network file system server providing shared data storage resources, and client systems. The server node receives and processes a document submitted by a client system. The document specifies a job including a number of compute tasks that are to be executed in a distributed manner by the compute nodes, data for at least one compute task of the job, a shared directory on the network file system server, and a collection of the compute nodes that have access to the shared directory. The server node stores the data for the compute task of the job into the shared directory. At least one compute node that belongs to the collection accesses the directory to process the data for the compute task of the job for execution of the compute task.

### BACKGROUND

1. Field

The present application relates to high performance distributed computing environments.

2. State of the Art

High performance distributed computing environments are typically based on the message-passaging interface (MPI) protocol, which is a language-independent communications protocol used to program parallel computers. MPI is not sanctioned by any major standards body; nevertheless, it has become a de facto standard for communication among processes that model a parallel program running in a distributed computing environment.

Most MPI implementations consist of a specific set of routines (i.e., an API) directly callable from C, C++, Fortran and any language able to interface with such libraries, including C#, Java or Python. The advantages of MPI over older message passing libraries are portability (because MPI has been implemented for almost every distributed memory architecture) and speed (because each implementation is in principle optimized for the hardware on which it runs). At present, the MPI standard has several popular versions, including version 1.3 (commonly abbreviated MPI-1), which emphasizes message passing and has a static runtime environment, and MPI-2.2 (MPI-2), which includes new features such as parallel I/O, dynamic process management and remote memory operations.

The MPI protocol is meant to provide essential virtual topology, synchronization, and communication functionality between a set of processes that have been mapped to nodes/servers/computer instances in a language-independent way, with language-specific syntax (bindings), plus a number of language-specific features. The MPI library functions include, but are not limited to, point-to-point rendezvous-type send/receive operations, choosing between a Cartesian or graph-like logical process topology, exchanging data between process pairs (send/receive operations), combining partial results of computations (gather and reduce operations), synchronizing nodes (barrier operation) as well as obtaining network-related information such as the number of processes in the computing session, current processor identity that a process is mapped to, neighboring processes accessible in a logical topology, and so on.

There are many different implementations of MPI, including private and open-source implementations such MPICH and Open MPI. In order to run a job (typically referred to as an application) utilizing MPI, the user sets up a host file that identifies all of the nodes on which the job will execute.

Batch systems have also been developed for MPI. For example, the Portable Batch System (PBS) system is commonly used to manage the distribution of batch jobs and interactive sessions across the available nodes in a cluster of MPI nodes. PBS consists of four major components: the User Interface, the Job Server, the Job Executor, and the Job Scheduler. The User Interface includes both a command line interface and a graphical interface. These are used to submit, monitor, modify, and delete jobs. The Job Server functions to provide the basic batch services, such as receiving/creating a batch job, modifying the job, protecting the job against system crashes, and initiating execution of job. The Job Executor places a job into execution when it receives a copy of the job from the Job Server. The Job Executor also has the responsibility for returning the job's output to the user when directed to do so by the Job Server. There must be a Job Executor running on every node that can execute jobs. The Job Scheduler contains a policy controlling which job is run and where and when it is run. This allows control over scheduling between sites. The Job Scheduler communicates with the various Job Executors to learn about the state of system resources and with the Job Server to learn about the availability of jobs to execute.

In order to run a job in PBS, a control script can be submitted to the PBS system using the qsub command: qsub [options] <control script>. PBS will then queue the job and schedule it to run based on the jobs priority and the availability of computing resources. The control script is essentially a shell script that executes the set commands that a user would manually enter at the command-line to run a program. The script may also contain directives that are used to set attributes for the job. The directives can specify the node requirements for the job. Such directives are implemented by a string of individual node specifications separated by plus signs (+). For example, 3+2: fast requests 3 plain nodes and 2 “fast” nodes. A node specification is generally one of the following types: the name of a particular node in the cluster, a node with a particular set of properties (e.g., fast and compute), a number of nodes, and a number of nodes with a particular set of properties (in this case, the number of nodes is specified first, and the properties of the nodes are specified second and separated by colons. Two properties that may be specified include:
shared: which indicates that the nodes are not to be allocated exclusively for the job; note that the shared property may only be used as a global modifier; and
ppn=<number of processors per node>: which requests a certain number of processors per node be allocated.

The node configuration in a PBS control script may also have one or more global modifiers of the form #<property> appended to the end of it which is equivalent to appending <property> to each node specification individually. That is, “4+5:fast+2:compute#large” is completely equivalent to “4:large+5:fast:large+2:compute:large.” The shared property is a common global modifier.

The following are some common PBS node configurations. For each configuration, both the exclusive and shared versions are shown. The first common PBS node configuration specifies a number of nodes as:

nodes=<num nodes>, or

nodes=<num nodes>#shared

The second common PBS node configuration specifies number of nodes with a certain number of processors per node as:

nodes=<num nodes>:ppn=<num procs per node>, or

nodes=<num nodes>:ppn=<num procs per node>#shared

The third common PBS node configuration specifies a list of specific nodes as:

nodes=<list of node names separated by ‘+’>, or

nodes=<list of node names separated by ‘+’>#shared

The fourth common PBS node configuration specifies a number of nodes with particular properties as:

nodes=<num nodes>:<property 1>″ . . . , or

nodes=<num nodes>:<property 1>: . . . #shared

MPI and PBS are not particularly suited for heterogeneous environments where the nodes employ different processing platforms and different storage architectures.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Illustrative embodiments of the present disclosure are directed to distributed computing systems and methods for high performance computing. In a specific embodiment, a distributed computing system includes a server node, a plurality of compute nodes, a network file system server providing shared data storage resources, and a plurality of client systems. The server node is configured to receive and process a document submitted by one of the client systems. The document specifies a job including a number of compute tasks that are to be executed in a distributed manner by the plurality of compute nodes, data for at least one compute task of the job, a shared directory on the network file system server, and a first collection of the compute nodes that have access to the shared directory. The server node is further configured to store the data for the at least one compute task of the job into the shared directory. At least one compute node that belongs to the first collection of compute nodes is configured to access the shared directory to process the data for the at least one compute task of the job for execution of the at least one compute task.

In one embodiment, the server node is configured to maintain a list of active compute nodes and to schedule the compute tasks of the job as specified by the document on active compute nodes that belong to the first collection of compute nodes.

In another embodiment, the data for the at least one compute task of the job as specified by the document can include at least one input file. The at least one input file can refer to at least one variable that is substituted dynamically at run time by operation of at least one compute node that belongs to the first collection of compute nodes. The data for the at least one compute task of the job as specified by the document can also include a program to be executed as part of the compute task.

At least one compute node that belongs to the first collection of compute nodes can be configured to access the shared directory to store results of execution of the compute tasks of the job. The server node can access the shared data in order to return the results of execution of the compute tasks for the job to the one client system that submitted the document that specified the job.

In one embodiment, the results of execution of the compute tasks of the job can include at least one output file, an error code or error message.

The plurality of compute nodes of the system can be heterogeneous in nature with different computer processing platforms and/or with a second collection of compute nodes that do not have access to the shared data storage resources of the network file server system.

The document that specifies the job can include a first element that identifies the job as a type involving the shared data storage resources of a network file system server. In this case, the server node can process the first element of the document in order to configure operations of the server node and the first collective of compute nodes for execution of the compute tasks of the job.

The server node can also be configured to receive and process other documents submitted by the plurality of client systems, wherein each respective other document specifies a job including a number of compute tasks that are to be executed in a distributed manner by the plurality of compute nodes, wherein the respective other document includes a second element that identifies the job as a type involving local data storage resources on the plurality of compute nodes. In this case, the server node processes the second element of the respective other document in order to configure operations of the server node and the plurality of compute nodes for execution of the compute tasks of the job.

In one embodiment, the document comprises an XML document.

The system can also include at least one manager node operably coupled between the server node and a number of compute nodes associated therewith. The at least one manager node monitors operational status of the number of compute nodes associated therewith and relays messages between the server node and the number of compute nodes associated therewith.

The system can also include a database management system operably coupled to the server node. The database management system can store information pertaining to the compute nodes of the system as well as information pertaining to the jobs executed by the compute nodes of the system.

The client systems can include a client application that operates to generate the document specifying the job. The client systems and the server node can include messaging interfaces that allow for communication of messages therebetween. The messaging interfaces can employ a standardized messaging protocol such as SOAP.

In one embodiment, the server node can be located remotely with respect to the client systems. The plurality of compute nodes can also be located remotely with respect to the client systems.

The compute tasks of the job specified by the document can carry out log modeling and inversion of tool responses in support of an oil and gas industry workflow.

Methods of operating the distributed computing system is also described and claimed.

### BRIEF DESCRIPTION OF THE DRAWINGS

FIG. 1 is a schematic block diagram of a distributed computer processing system according to an embodiment of the present application.

FIG. 2A is a schematic diagram of parts of the G4 Server Node of FIG. 1 according to an embodiment of the present application.

FIG. 2B is a schematic diagram of parts of the Client Systems of FIG. 1 according to an embodiment of the present application.

FIG. 2C is a schematic diagram of parts of the G4 Database System of FIG. 1 according to an embodiment of the present application.

FIG. 2D is a schematic diagram of parts of the G4 Manager Node of FIG. 1 according to an embodiment of the present application.

FIG. 2E is a schematic diagram of parts of the Compute Nodes of FIG. 1 according to an embodiment of the present application.

FIG. 2F is a schematic diagram of parts of the NFS Server System of FIG. 1 according to an embodiment of the present application.

FIG. 3 is a schematic diagram illustrating exemplary operations of the distributed computer processing system of FIG. 1 during registration and during the processing of a document that specifies a job that involves a fully-distributed mode of operation by the system.

FIG. 4 is a schematic diagram illustrating exemplary operations of the distributed computer processing system of FIG. 1 during the processing of a document that specifies a job that involves a tightly-coupled mode of operation by the system.

### DETAILED DESCRIPTION OF THE PREFERRED EMBODIMENTS

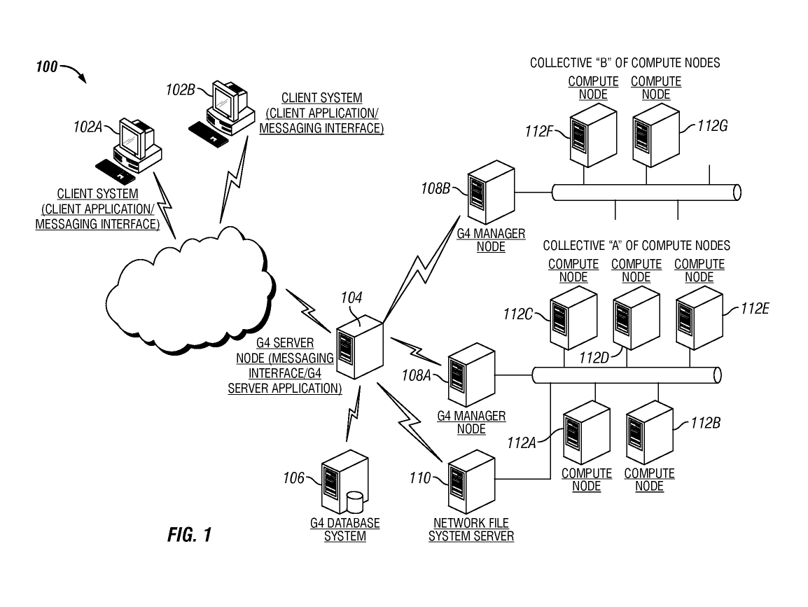

Illustrative embodiments of the present disclosure are directed to a distributed computing environment 100 as shown in FIG. 1, which includes a number of distributed computer processing systems that communicate with one another via interprocess networked communication (e.g., Internet sockets, pipes or message passaging mechanisms). These computer processing systems include at least one Client System 102 (and typically a number of Client Systems such as the two shown as 102A and 102B), at least one Server Node 104 (referred to as a “G4 Server Node”), a Database System 106 (referred to as a “G4 Database System”), at least one Manager Node 108 (referred to as a “G4 Manager Node” such as the two shown as 108A and 108B), at least one Network File System Server 110, and a number of Compute Nodes 112 (such as the seven shown as 112A, 112B, 112C, 112D, 112E, 112F, 112G). Each one of the computer processing systems of the G4 HPC Environment 100 includes a computer processing platform (an operating system executing on computer processing hardware). The operating system includes a network stack that supports interprocess networked communication (e.g., Internet sockets, pipes or message passaging mechanisms) between the distributed systems of the G4 HPC Environment as required. In one embodiment, the G4 HPC Environment 100 utilizes a proprietary python-to-python socket-based protocol (“pipc”) as part of the OS network stack of the G4 Server Node(s) 104, the G4 Database System 106, the G4 Manager Node(s) 108 and the Compute Nodes 112 in order to provide for network communication between such systems. The computer processing hardware of such computer processing systems can include local block storage devices (such as hard disks or solid-state drives) or possibly networked block storage accessible over a storage area network and the like. The computer processing systems of the G4 HPC Environment 100 can be implemented by a number of different computer systems. Alternatively, one or more computer processing systems of the G4 HPC Environment 100 can be implemented as virtual machines within a single computer system (or virtual machines with multiple computer systems).

The Compute Nodes 112 of the G4 HPC Environment 100 can be logically grouped together to form one or more Collectives. In one embodiment, all Compute Nodes 112 that the G4 Server Node 104 becomes aware of are in a “default” Collective, unless explicitly removed by an administrator. Each Compute Node 112 can also belong to a “self” Collective of one. In this case, the name of the Collective can be equated to the fully qualified name of the given Compute Node 112. The “self” Collective allows a job to be run on an individual Compute Node, if desired. Other Collectives can be created manually by an administrator using other criteria. For example, the Compute Nodes 112 can be heterogeneous in nature where the Compute Nodes employ different processing platforms (such as Unix/Linux operating systems and Windows operating systems operating system for specific processor architectures such as x86 or x64 processor architectures) and different storage architectures (such as block storage and/or network file system storage). In this case, Collectives can be formed for one or more Compute Nodes 112 with a given computer processing platform, one or more Compute Nodes 112 with a certain set of capabilities, one or more Compute Nodes 112 belonging to a particular administrative group, etc. One or more Collectives can also be defined for a number of Compute Nodes (such that the Compute Nodes 112A, 112B, 112C, 112D, 112E of FIG. 1) that share access to a Network File System Server as shown in FIG. 1. Note that the collective “A” can be managed by a corresponding G4 Manager Node 108A as shown. In this case, the G4 HPC Environment 100 includes additional Compute Nodes (for example, Nodes 112F and 112 G as shown in FIG. 1) that are not part of the Collective “A” and do not have access to the Network File System Server 110 but are part of another Collective B. These other two Nodes 112F and 112G can be managed by another G4 Manager Node 108B as shown. Other configurations are also possible.

The G4 Server Node(s) 104, the G4 Database System 106, and the G4 Manager Node(s) 108 of the G4 HPC Environment 100 can be co-located with one another on the same premises. In this case, communication between these systems can occur over a local area network or campus area network that extends over the premises. The local area network can employ wired networking equipment (such as Ethernet networking equipment) and/or wireless networking equipment (such as Wi-Fi networking equipment). Alternatively, one or more of these systems can be remotely located with respect to the other systems over multiple premises. In this case, communication between these systems can occur over a wide area network such as the Internet. The wide area network can employ wired networking equipment (such as Ethernet and/or fiber optic networking equipment) and/or wireless networking equipment (such as Wi-Max networking equipment). The Compute Nodes 112 can be located on the same premises. In this case, communication between the Compute Nodes 112 can occur over the local area network or campus area network that extends over the premises. The Client Systems 102 can be located remotely from the G4 Server Node(s) 104, the G4 Database System 106, and the G4 Manager Node(s) 108 of the G4 HPC Environment 100. In this case, communication between the Client Systems 102 and at least the G4 Server Node(s) 104 can occur over a wide area network such as the Internet. The wide area network can employ wired networking equipment (such as Ethernet and/or fiber optic networking equipment) and/or wireless networking equipment (such as Wi-Max networking equipment). One or more of the Compute Nodes 112 can also be remotely located with respect to one another (such as clusters of Compute Nodes located on different premises). One or more of the Compute Nodes 112 can also be remotely located with respect to the other systems of the G4 HPC Environment 100. For example, it is possible that Client System 102 can host both the Client Application and G4 agent application as thus embody the functionality of both the Client System 102 and Compute Node 102 as described below.

### G4 Server Node

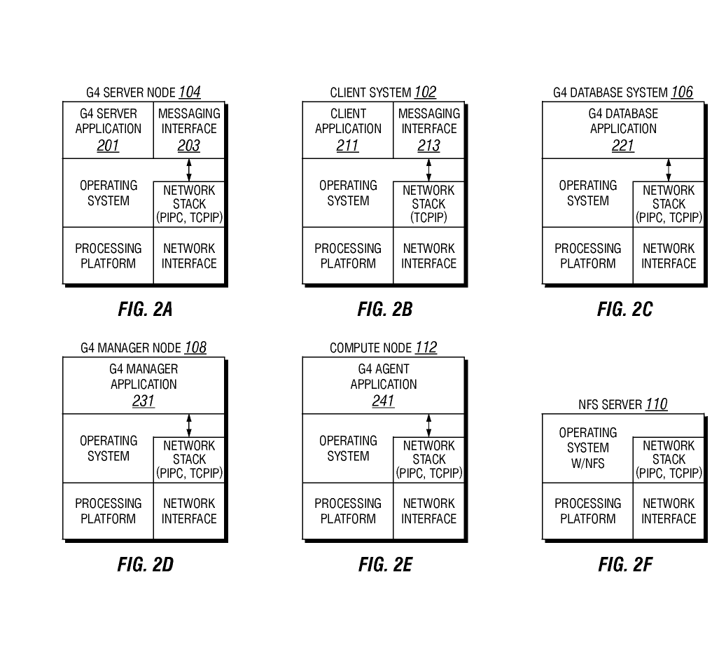

The G4 Server Node 104 includes a G4 Server Application 201 and a Messaging Interface 203 that is stored and executed on the computer processing platform of the G4 Server Node 104 as shown in FIG. 2A. The Messaging Interface 203 provides a messaging framework between the G4 Server Node 104 and Client Systems 102 of the G4 HPC Environment 100. The messaging framework is preferably based upon standard distributed messaging protocols. In one example, the messaging framework employs the SOAP protocol to communicate structured messages to the Client Systems 102. The G4 Server Application 201 utilizes the OS network stack of the G4 Server Node 104 to communicate to the Client Systems 102 via the Messaging Interface 203, to the one or more G4 Manager Nodes 108, to the G4 Database System 108 and to the Network File System Server(s) 110 of the G4 HPC Environment 100. The OS network stack of the G4 Server Node 104 supports the distributed file system protocol of the Network File System Server(s) 110, such as NFS version 4 or SMB/CIFS.

### Client System

The Client System 102 includes a Client Application 211 and Messaging Interface 213 that is stored and executed on the computer processing platform of the Client System 102 as shown in FIG. 2B. The Messaging Interface 213 supports the messaging framework of the Messaging Interface 203 of the G4 Server Node(s) 104 of the G4 HPC Environment 100. The Client Application 211 utilizes the Messaging Interface 213 in conjunction with the OS network stack of the Client System 102 to communicate to the G4 Server Node 104 via the Messaging Interface 201 of the G4 Server Node 104. The communication between the Client System 102 and the G4 Server Node 104 can be carried out over a wide area network (such as the Internet) or possibly over a local area network. The network communication between the Client System 102 and the G4 Server Node 104 can be protected by security measures, such as with the HTTPS protocol or a VPN tunnel as is well known. In one embodiment, the Client application 211 and the Messaging Interface 213 has limited control over the operation of the core components (the G4 Server Node(s), the G4 Database System, the G4 Manager Node(s), the Compute Nodes) of the G4 HPC Environment 100, including managing user accounts maintained by G4 Database System 106, authenticating users via a login process (such as user submission of a user name and password), uploading programs (or program packages) by users for storage in the G4 Database System 106 where such programs are used in jobs specified by the users, submission of jobs by users for execution by the core components of the G4 HPC Environment 100, deleting (or aborting) a job that is scheduled for execution (or currently be executed) by the core components of the G4 HPC Environment 100, and querying the status of jobs that are currently being executed by the core components of the G4 HPC Environment 100. These functions can be carried out through standard web services (such a messaging framework employing the SOAP protocol) between the Client System 102 and the G4 Server Node 104. The submission of a job by a user can involve the communication of an XML document that specifies the job from the Client System 102 to the G4 Server Node 104 as described below. The program(s) for a specific job can be uploaded by the user and stored in the G4 Database System 106, or possibly loaded offline into the G4 Database System 106 by an administrator or by some other suitable method.

### G4 Database System

The G4 Database System 106 includes a G4 Database Application 221 that is stored and executed on the computer processing platform of the G4 Database System 106 as shown in FIG. 2C. The G4 Database Application 221 of the G4 Database System 106 utilizes the OS network stack of the G4 Database System to communicate with the G4 Server Node 104 to store information maintained by the G4 HPC Environment 100. In one embodiment, the information stored by the G4 Database System 106 includes the following for each given job:
jobID: an identifier assigned to a given job;
ownerID: an identifier assigned to a user who submitted the XML document specifying the given job;
serverID: an identifier assigned to the G4 Server Node 104 that processed the XML document specifying the given job;
jobName: a name assigned to the given job;
created: a time-stamp generated by the G4 Server Node 104 indicating creation of the given job as a result of processing the XML document specifying the given job;
expires: a time-stamp generated by the G4 Server Node 104 when automatically removing the given job; this time stamp identifies the time for deleting the given job;
after: a time-stamp generated by the G4 Server Node 104 when automatically scheduling the given job; this time stamp identifies the start time for the given job;
ready: a time-stamp generated by the G4 Server Node 104 in tracking status of the given job; this time stamp identifies the time when the given job is ready to run;
completed: a time-stamp used by the G4 Server Node 104 in tracking status of the given job; this time stamp identifies the time when the given job is completed;
state: a state variable indicating the state of the given job, i.e., ready/completed/aborted;
exitMessage: a message generated if the given job results in an error;
cores: a parameter representing computer platform resources (such as a minimum number of processing cores) required by all Compute Nodes 112 that run a task for the given job;
priority: a parameter used by the G4 Server Node for scheduling compute tasks of the given job;
retryCount: a parameter used by the G4 Server Node 104 to automatically schedule re-execution of the compute tasks for the given job; specifically, the compute task(s) for the given job will be automatically re-executed unless retrycount for the compute task has been exceeded;
saveWork: a parameter representing whether or not to save the working directory for the compute tasks of a given job; by default, the working directory is saved if a task fails; this is done for debugging purposes; this parameter can override the default setting for all compute tasks for the given job or for any individual compute task.
taskCount: a parameter representing the number of compute tasks for the given job;
jdfID: a pointer to copy of the XML document that specifies the given job; and
jobDir: a pointer to a directory maintained by the Network File System Server 110 for a Collective of the G4 HPC Environment 100; this is used by the core components of the G4 HPC Environment 100 in the tightly coupled mode of operation as described below.

The information stored by the G4 Database Application 221 of the G4 Database System 106 an also include the following for each given Compute Node 112 of the G4 HPC Environment 100:
nodeID: an identifier assigned to the given Compute Node 112;
agentID: an identifier assigned to the G4 agent executing on the given Compute Node 112;
configID and platformID: identifiers that identify the configuration and platform-types of the computer processing platform of the given Compute Node 112; and
managerID: an identifier that identifies the G4 Manager Node 108 that manages the given Compute Node 112.

The information stored by the G4 Database Application 221 of the G4 Database System 106 can also include the following for each given Collective of the G4 HPC Environment 100:
collectiveID: an identifier assigned to the given Collective; and
nodeID; the identifier for each Compute Node 112 that is part of the given Collective.

The information stored by the G4 Database Application 221 of the G4 Database System 106 can also include information specific to each given compute task of the jobs executed on the Compute Nodes 112 of the G4 HPC Environment 100. Such information can include the following:
taskID: an identifier assigned to the given compute task;
jobID: an identifier for the job to which the given compute task belongs; and
agentID: an identifier for the G4 agent application that has been assigned to execute the given compute task;
executable: one or more binary images that make up a program for the given compute task, the binary images of the program encode the sequence of instructions for the given compute task;
inputs: zero or more input files specifying input data that is consumed by execution of the given compute task;
outputs: zero or more output files specifying output data that results from execution of the given compute task;
environment: zero or more environment variables for the given compute task;
taskCompleted: a status flag that indicates whether or not the given compute task has completed execution; and
taskFailed: a status flag that indicates whether or not the given compute task has failed execution.

The information stored by the G4 Database Application 221 of the G4 Database System 106 can also include information related to the compute tasks of the jobs executed on the Compute Nodes 112 of the G4 HPC Environment 100. Such information can include the following:
activeTaskLimit: a parameter representing a limit on the number of running tasks in a job; the default can be unlimited, but this may be changed in order to limit how many tasks are allowed to run concurrently for the job;
jobTimeout: a parameter representing when the job information can be purged from the G4 Database System and when the job inputs and outputs can be purged from the Compute Nodes that execute the compute tasks of the job; usually this will be done hours or days after the completion of the job; this parameter also specifies how long the job is allowed to run before it is considered “runaway” and needs to be aborted, which prevents infinitely-running jobs due to errors in the user code, node or network failures, or other unforeseen reasons; and
taskTimeout: a parameter representing the maximum duration of execution of a given compute task before a timeout occurs; this parameter is used by the G4 Manager Node(s) 108 of the G4 HPC Environment 100 to automatically determines whether task timeout has occurred due to an error and requires re-execution of the compute task.

In one embodiment, the G4 Database Application 221 is implemented by a commercially-available SQL database application, such as a version of the open-source MySQL database application.

### G4 Manager Node

The G4 Manager Node 108 includes a G4 Manager Application 231 that is stored and executed on the computer processing platform of the G4 Manager Node 108 as shown in FIG. 2D. The G4 Manager Application 231 utilizes the OS network stack of the G4 Manager Node 108 to communicate to the G4 Server Node 104 and to a number of associated Compute Nodes 112 of the G4 HPC Environment.

### Compute Node

The Compute Node 112 includes a G4 Agent Application 241 that is stored and executed on the computer processing platform of the Compute Node 112 as shown in FIG. 2E. The G4 Agent Application 241 utilizes the OS network stack of the Compute Node 112 to communicate with the G4 Manager Node 108 associated therewith and possibly to the Network File System Server 110 of the G4 HPC Environment if part of a Collective with access to the Network File System Server 110. The OS network stack of the Compute Node 112 can support the distributed file system protocol of the Network File System Server 110, such as NFS version 4 or SMB/CIFS.

### Network File System Server

The operating system of the Network File System Server 110 is configured to employ the resources of its computer processing platform to stores files in a network file system as shown in FIG. 2F. The network file system is accessible by the Compute Nodes 112 of one or more Collectives (such as Collective A of FIG. 1) as well as the G4 Server Node 104 of the G4 HPC Environment 100. The Network File System Server 110 utilizes the OS network stack of the Network File System Server 110 to communicate with the G4 Server Node 104 and to the associated Compute Nodes 112 of the G4 HPC Environment. The Network File System Server 110 can employ a distributed file system protocol such as NFS version 4 or SMB/CIFS.

### Workflow of the System

The G4 HPC Environment 100 is configured to process jobs as specified by the Client Application 211 of one or more Client Systems 102 of the G4 HPC Environment 100. A job is a number of compute tasks (i.e., work-items) that are distributed over the Compute Nodes 112 of the G4 HPC Environment 100 by operation of the G4 Server Node 104.

In one embodiment, the Client Application 211 of the Client System 102 includes a command-line interface that generates an XML document that specifies a particular job and communicates the XML document to the G4 Server Node 104. The Client System 102 and the G4 Server Node 104 can utilize the SOAP protocol for exchanging the XML document that specifies the particular job. Other suitable messaging protocols and distributed programming interfaces can also be used. The command line interface can also provide for additional functions, such as monitoring the progress of a job submitted by the user, downloading the results from a job submitted by the user; monitoring the progress of any output file from a job submitted by the user, monitoring statistics of a job submitted by the user, or deleting or aborting a job submitted by the user.

The G4 HPC Environment 100 can implement role-based security based upon the following roles: User, Developer, Admin, and Root. All of the roles require user authentication by a login process carried out by the G4 Server Node 104 in order to perform the designated functions of the specific role. The User role needs to have a corresponding user account maintained on the G4 Database System 106 in order to be able perform various functions. The User role can specify jobs and can perform a limited set of additional functions (such as monitoring the progress of a job submitted by the user, downloading the results from a job submitted by the user monitoring the progress of any output file from a job submitted by the user, monitoring statistics of a job submitted by the user, or deleting or aborting a job submitted by the user). The Developer role can perform the functions of the User role and also load programs into the G4 Database System 106 for use in jobs executed by the G4 HPC Environment 100. The Admin role can perform the functions of the User and Developer roles and can also add/delete users and change User roles. The Root role can perform any function on the system, including adding or modifying the information stored on the G4 Database System 106 and viewing/controlling jobs of all users.

The XML document for a job specifies a list of compute tasks that are to be computed together with one or more input files and one or more output files. Each compute task is an instruction to run a program, which is the label given to a collection of binary images. A binary image is specific to a particular computing processing platform of the Compute Nodes 112 (i.e., the operating system and hardware combination of the respective Compute Node, such as Linux-i686, Linux-ia32, Windows-x86, etc.). A group of related programs can be labeled as belonging to an application (for example, “WebMI”). Such applications are unique to a given user. In other words, application X to user A is not the same as application X to user B. Programs may have different versions. There is a default version of a program, which is used if the user does not explicitly specify a version. Programs are stored in the G4 Database System 106 by the G4 Server 104 in a hierarchical structure including user/application/program/platform/version.

The XML document for a job can specify the Collective that is to be used to process the job. In this case, the Compute Nodes 112 that belong to the specified Collective can be used to process the job. In the event that the XML document does not specify a Collective, the “default” Collective can be used to process the job.

The XML document for a job can also specify a particular computing processing platform that that is to be used to process the job. In this case, the Compute Nodes 112 that match this particular computing processing platform can be used to process the job. In the event that the XML document does not specify a particular computing processing platform that is to be used to process the job, and multiple versions of the program for the job exists for different computing processing platforms, the job can be processed by the Compute Nodes 112 of the G4 HPC Environment 100 that are realized by one or multiple platforms that support the program for the job.

The Messaging Interface 201 of the G4 Server Node 104 operates to receive the XML document communicated from the Client System 102. The G4 Server Application 203 executing on the G4 Server Node 104 parses the received XML document to derive a list of compute tasks (i.e., work-items) for the particular job as specified in the XML document. The G4 Server Application 203 assigns the compute tasks of this list to one or more Compute Nodes 112 that are available and capable of executing the compute tasks. When the respective Compute Node has finished execution of a given compute task, the output file(s) generated by the Compute Node as a result of the execution of the compute task are made available to the G4 Server Mode 104, and then such output file(s) are communicated from the G4 Server Node 104 to the Client System 102 that issued the XML document for the job.

Both the G4 Server Application 201 executing on the G4 Server Node 104 and the G4 Manager Application 231 executing on the G4 Manager Node(s) 108 maintain a list of active Compute Nodes associated therewith together with data that represents zero or more types of compute tasks that can be executed on each active Compute Node. The G4 Manager Application 231 on the G4 Manager Node(s) 108 adds a given Compute Node to the list of active Compute Nodes when the G4 Agent Application 241 executing the given Compute Node 112 communicates a “Registration” message to the G4 Manager Node 108. The G4 Manager Application 231 is configured to forward the received “Registration” message to the G4 Server Node 104. The G4 Server Application 201 adds the given Compute Node to the list of active Compute Nodes when it receives the “Registration” message forwarded by the G4 Manager Node 108. The “Registration” message communicated by a given Compute Node 112 can include information that characterizes the computing resources of the given Compute Node, such as the operating system of the Computer Node, the number of processing cores of the Compute Node, the operating frequency of the processing core(s) of the Compute node, and information about the memory system of the Compute Node (such as total size of system memory, size and/or speed of cache memory, etc.).

The G4 Manager Application 231 executing in the respective G4 Manager Node 108 is also configured to listen for periodic “heartbeat” messages (for example, every 20 seconds) communicated from active Compute Node(s) 112 associated therewith. The “heartbeat” message can include the following information:
the amount of free memory on the Compute Node;
a flag indicating whether or not the Compute Node is busy (i.e., currently executing one or more compute tasks); and
a list of zero or more compute tasks that are currently executing on the Compute Node.

The G4 Manager Application 231 executing on the G4 Manager Node 108 is configured to forward each received “heartbeat” message to the G4 Server Node 104. The G4 Server Application 201 executing on the G4 Server Node 104 replies to the “heartbeat” message with “taskInfo” data that is communicated back to the G4 Agent Application 241 of the given Computer Node via the G4 Manager Node 108. The “taskInfo” data can be empty, for example, in the event that the G4 Server Application 201 determined that there are no compute tasks that are appropriate for execution on the given Compute Node. The “taskInfo” data can also specify the details of a particular compute task, for example, in the event that the G4 Server Application 201 determines that the particular compute task is appropriate for execution on the given Compute Node. In one embodiment, the “taskInfo” data includes the following information:

| | |
|---|---|
| AgentID: | an identifier of the G4 Agent Application 241 that is scheduled to |
| | execute the compute task; |
| Args: | arguments for the computer task; these are |
| | command-line arguments that can be passed to the program |
| | of the compute task (also known as “argv” in a main |
| | function); these arguments are arbitrary and user-defined. |
| Completed: | a timestamp indicating when the compute task has been |
| | completed; this timestamp is generated by the G4 Agent |
| | Application 241 after completion of the compute task; |
| Cpu: | duration of CPU processing time (seconds) for the compute |
| | task; this duration is determined by the G4 Agent |
| | Application 241 after completion of the compute task; |
| Dispatched: | a timestamp indicating when the compute task was |
| | dispatched to the G4 Agent Application 141; this timestamp |
| | is generated by the G4 Server Application 201 upon |
| | dispatching the compute task to the G4 Agent Application 241 via |
| | the appropriate G4 Manager Node; |
| EnvVars: | list of environment variables for the compute task, such as |
| | location of a folder containing dynamic link libraries for |
| | the compute task), or any other standard (Linux or |
| | Windows) environment variables or user-defined |
| | environment variables for the compute task. |
| Execute: | duration of elapsed time (seconds) for the compute task; this |
| | duration is determined by the G4 Agent Application 241 |
| | after completion of the compute task; this is different than |
| | CPU time because it includes time for overhead processing |
| | that is not specifically part of the compute task, such as OS, |
| | I/O, and other overhead. |
| ExitCode: | exit code for the compute task; this code is generated by the |
| | G4 Agent Application 241 during the exit processing of the |
| | compute task; |
| ExitMessage: | exit message for the compute task; this message is |
| | determined by the G4 Agent Application during the exit |
| | processing of the compute task; |
| Fetched: | a timestamp generated by the G4 Server Application 201 |
| | indicating when the compute task was fetched for |
| | scheduling by the G4 Server Application 201; |
| Outputs: | a list of information related to output files created by the |
| | compute task; such information can includes output file |
| | names, flags (such as ‘executable’, ‘text’, ‘zip’), and a count |
| | for the number of output files; |
| FinishOrder: | information describing the order in which the compute task |
| | has been completed; |
| Inputs: | a list of information related to input files that are consumed |
| | by execution of the compute task; such information can |
| | includes input file names and identifiers, flags (such as |
| | ‘executable’, ‘text’, ‘zip’), and a count for the number of |
| | input files; |
| JobID: | a jobID for the job to which the compute task belongs; |
| Memory: | an indication, if known apriori, of how much memory the |
| | compute task needs; |
| State: | a state variable representing state of the compute task, such |
| | as ready, active, completed, aborted; |
| Tag: | an identifier or tag for the compute task; this is an |
| | alphanumeric label that can be assigned to the compute task |
| | by the user or by the system; it should be unique within a |
| | given job; |
| TaskID: | a task identifier assigned to the compute task by the G4 |
| | Database system; it is essentially the primary key of the |
| | Task table and is unique for each task, regardless of which |
| | job to which it belongs; |
| Timeout: | a parameter (seconds) representing the maximum duration |
| | of execution of a given compute task before a timeout |
| | occurs; this parameter is used by the G4 Manager |
| | Application 231 to automatically determine that has task |
| | timeout has occurred due to an error and requires re- |
| | execution of the compute task; |
| Download: | duration of elapsed time (seconds) that the G4 Agent |
| | Application 241 takes to read a copy of the input files; the |
| | copy can be read from the G4 Manager Node 108 in the |
| | fully distributed mode or from the directory of the NFS |
| | Server 110 in the tightly-coupled mode as described below; |
| DownloadBytes: | byte count of input file copies read by the G4 Agent |
| | Application 241; |
| DownloadCount: | number of input file copies read by the G4 Agent |
| | Application 241; |
| Upload: | duration of elapsed time (seconds) that the G4 Agent |
| | Application 241 took to write a copy of the output files; the |
| | copy can be written to the G4 Manager Node 108 in the |
| | fully distributed mode or to the directory of the NFS Server |
| | 110 in the tightly-coupled mode as described below; |
| UploadBytes: | byte count of output file copies written by the G4 Agent |
| | Application 241; |
| UploadCount: | number of output file copies written by the G4 Agent |
| | Application 241; |

If the received “taskInfo” data specifies the details of the particular compute task, the G4 Agent Application 241 executing on the Compute Node 112 is configured to launch a new thread that will execute the particular compute task. The G4 Agent Application 241 sends periodic “Heartbeat” messages to the appropriate G4 Manager Node 108 while the compute task is being executed.

In one embodiment, the G4 Server Application 201 executing on the G4 Server Node 104 assigns the compute tasks to active Compute Nodes 112 of the G4 HPC Environment 100 in a manner that ensures that the compute tasks get approximately equal share of CPU time of the Computer Nodes of the G4 HPC Environment 100. This feature is advantageous in a multi-user environment. Without it, a situation can arise where one user with a highly time-consuming job gets complete control of the Compute Nodes 112 of the G4 HPC Environment 100 and renders all other jobs inoperable for a long period of time. Note that other assignment schemes can be used. For example, dynamic assignment schemes that prioritize certain compute tasks over other compute tasks can possibly be used.

When the G4 Manager Application 231 executing on the G4 Manager Node 108 fails to receive the periodic “heartbeat” message from a given active Compute Node within a predetermined time period (which can be dictated by the “Timeout” parameter as specified in the “taskInfo” data for the compute task), the G4 Manager Application 231 can automatically remove the given Compute Node from its list of active Compute Nodes and sends a “Compute Node Inactive” message that identifies the inactive status of the corresponding Compute Node to the G4 Server 104. When the G4 Server Application 201 executing on the G4 Server Node 104 receives the “Compute Node Inactive” message from the G4 Manger Node 108, the G4 Server Application 201 can automatically remove the given Compute Node from its list of active Compute Nodes and also reset the execution status of any compute task that were being executed on the given Compute Node so that the G4 Server Application 201 can re-assign the compute task to another suitable Compute Node for execution thereon.

In summary, the G4 Server Application 201 executing on the G4 Server Node 104 manages a queue of compute tasks of the job specified by the invoking Client application executing on the Client System 102. It operates to maintain awareness of the amount of work to be performed; to keep track of the computing resources available for this work (considering that the availability of the Compute Nodes of the G4 HPC Environment 100 may frequently change), and distribute compute tasks to the available Compute Nodes of the G4 HPC Environment 100.

In one embodiment, the XML Document for a specific job can specify whether the job should be processed in a select one of two modes, including a fully distributed mode (referred to as mode A) or a tightly coupled mode (referred to as mode B).

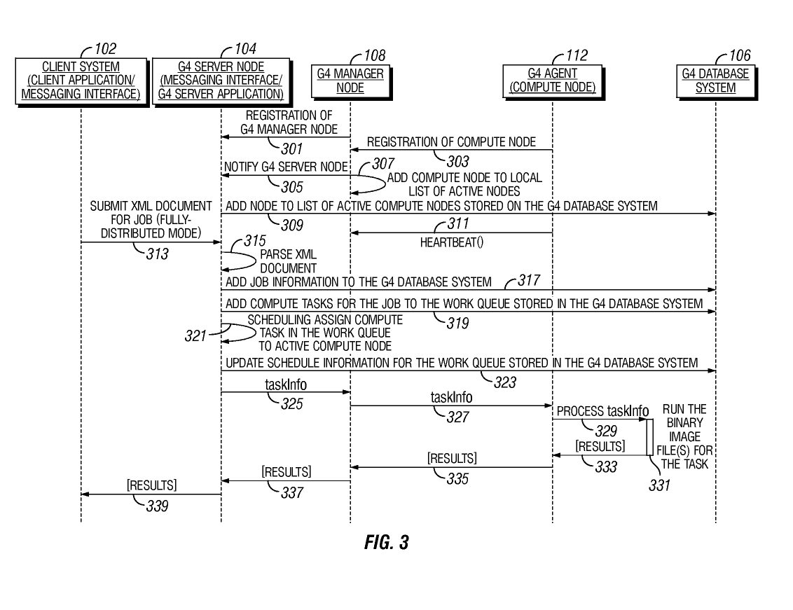

In mode A, the job data (i.e., the input data file(s) and the binary image file(s) for the job) are not stored on the Network File System Server 110, but instead are communicated as part of the “taskInfo” data communicated from the G4 Server Node 104 to the Compute Node(s) via the corresponding G4 Manager Node 108 as a result of scheduling process carried out by the G4 Server Node 104. The G4 Manager Node 108 and associated Compute Node(s) 112 can utilize cache memory to store the input data file(s) and the binary image file(s) of the job, if desired. The Compute Node utilizes the stored input file(s) and binary image file(s) to carry out the compute task. The Compute Node may request the data files from the G4 Manager Node 108 if missing. The output data file(s) for the compute task are not stored on the Network File System Server 110, but instead are communicated as part of results communicated from the Compute Node to the G4 Server Node 104 via the corresponding G4 Manager Node 108 upon completion of the compute task. The results can be stored in cache memory of the Compute Node(s) and the G4 Manager Node, if desired. Details of Mode A are described below with respect to FIG. 3.

The operations of FIG. 3 begin in step 301 where the G4 Manager Application 231 executing on the G4 Manager Node 108 registers with the G4 Server Node 104 as part of its start-up sequence.

In step 303, the G4 Agent Application 241 executing on the Compute Node 108 registers with the appropriate G4 Manager Node 108 as part of its start-up sequence. In response to such registration, the G4 Manager Node 108 notifies the G4 Server Node 108 of such node registration in step 305 and adds the compute node to a local list of active compute nodes in step 307. In response to receipt of the notice of node registration, the G4 Server Application 201 executing on the G4 Server Node 104 cooperates with the G4 Database Application 221 executing on the G4 Database System 106 to add the active Compute Node to the list of active Compute Nodes stored on the G4 Database System 106 in step 309.

In step 311, the G4 Agent Application 241 executing on the Compute Node sends the periodic heartbeat message to the appropriate G4 Manager Node 108.

In step 313, the Client Application 211 executing on the Client System 102 submits an XML document that specifies a job to the G4 Server Node 104 for execution in a fully-distributed mode as described herein. Upon receipt of the XML document that specifies the job, the G4 Server Application 201 executing on the G4 Server Node 104 parses the XML document to generate information for the job in step 315 and cooperates with the G4 Database Application 221 executing on the G4 Database System 106 to store such job information on the G4 Database System 106 in step 317.

In step 319, the G4 Server Application 201 executing on the G4 Server Node 104 cooperates with the G4 Database Application 221 executing on the G4 Database System 106 to add the compute tasks of the job to a work queue stored on the G4 Database System 106.

In step 321, the G4 Server Application 201 executing on the G4 Server Node 104 performs a scheduling process that assigns compute tasks in the work queue stored on the G4 Database System 106 to the active Compute Nodes. This scheduling process assigns the compute tasks for the job to the active Compute Nodes that belong to the Collective specified for the job.

In step 323, the G4 Server Application 201 executing on the G4 Server Node 104 cooperates with the G4 Database Application 221 executing on the G4 Database System 106 to update schedule information (which indicates which active Compute Node has been assigned the given compute task) for the work queue stored on the G4 Database System 106.

In step 325, the G4 Server Application 201 executing on the G4 Server Node 104 generates and sends the “taskInfo” data for the compute task to the appropriate G4 Manager Node 108 associated with the active Compute Node to which the compute task had been assigned in step 321. In step 327, the G4 Manager Node 108 forwards on the “taskInfo” data for the compute task to the active Compute Node to which the compute task had been assigned in step 321.

In step 329, the G4 Agent Application 241 executing on the given Compute Node receives and processes the “taskInfo” data for the compute task in order to initiate execution of the program of the compute task on the Compute Node, which occurs in step 331.

The operation of the G4 Agent Application 241 of step 329 can involve variable substitution. In this case, the “taskInfo” data for the compute task as generated by the G4 Server Node 104 includes information that specifies a list of one or more variables that are to be substituted along with values for the substituted variable(s). The G4 Agent Application 241 reads a copy of the input file(s) for the compute task from the G4 Manager Node 108 and utilizes the variable substitution information of the “taskInfo” data to carry out the variable substitution for the respective input file, which replaces the substituted variable(s) of the respective input file with the appropriate value(s) as specified by the “taskInfo” data and stores the updated input file for use in carrying out the compute task.

In step 333, when the execution of the program of the compute task on the Compute Node is complete, the G4 Agent Application 241 executing on the Compute Node collects the results of such execution (i.e., the output files and/or any error codes, if any) and forwards such results to the G4 Manager Node 108 in step 335.

In step 337, the G4 Manager Application 231 executing on the G4 Manager Node 108 forwards such results to the G4 Server Node 104. The G4 Server Application 201 executing on the G4 Server Node 104 can cooperate with the G4 Database Application 221 executing on the G4 Database System 106 to store the results of the compute task on the G4 Database System 106. In step 339, the G4 Server Application 201 executing on the G4 Server Node 104 can also forward such results to the Client Application that issued the job (step 313) as appropriate.

The periodic heartbeat messages of step 311 can also be communicated during execution of a compute task by the Compute Node. As described above, in the event that the appropriate G4 Manager Node 108 fails to receive the periodic “heartbeat” message from a given active Compute Node within a predetermined time period (which can be dictated by the “Timeout” parameter as specified in the “taskInfo” data for the compute task), the G4 Manager Application 231 can automatically remove the given Compute Node from its list of active Compute Nodes and sends a “Compute Node Inactive” message that identifies the inactive status of the corresponding Compute Node to the G4 Server 104. When the G4 Server Application 201 executing on the G4 Server Node 104 receives the “Compute Node Inactive” message from the G4 Manger Node 108, the G4 Server Application 201 can automatically remove the given Compute Node from its list of active Compute Nodes and also reset the execution status of any compute task that were being executed on the given Compute Node so that the G4 Server Application 201 can re-assign the compute task to another suitable Compute Node for execution thereon. Such heartbeat processing can be used to dynamically identify node failures or shutdowns during the execution of a compute task and allow the G4 Server Application 201 to re-assign the compute task to another suitable Compute Node for execution thereon.

In Mode B, the job data (i.e., the input data file(s) and possibly the binary image file(s) for the job) are stored in a particular directory of the Network File System Server 110. This directory is specified in a configuration file on the Network File System Server 110. When the G4 Agent application executing on a Compute Node 112 connects to the Network File System Server 110, this information is passed from the Network File System Server 110 to the G4 Agent application executing on a Compute Node 112, which stores such information for subsequent use. The “taskInfo” data for the compute tasks as communicated from the G4 Server Node 104 to the Compute Nodes 112 via the corresponding G4 Manager Node 108 as a result of scheduling process carried out by the G4 Server Node 104 include pointers to such files as stored on the Network File System Server 110. The Compute Nodes that process the compute tasks for the job utilizes these pointers to access the Network File System Server 110 to read the input data file(s) and possibly the binary image file(s) for the job, and then use these files in processing the task for the job. Each Compute Node writes the output file(s) for the job to the Network File System Server 110. Upon completion of the compute task and writing the output file(s) for the job to the Network File System Server 110, the Compute Node sends a “TaskComplete” message to the G4 Server Node 104 via the corresponding G4 Manager Node 108. In this case, the “TaskComplete” message communicated to the G4 Server Node 104 does not include the output file(s). Instead, upon receiving the “Task Complete” message, the G4 Server Node 104 accesses the output file(s) from the Network File System Server 110 in order to return such output file(s) to the requesting Client System 102.

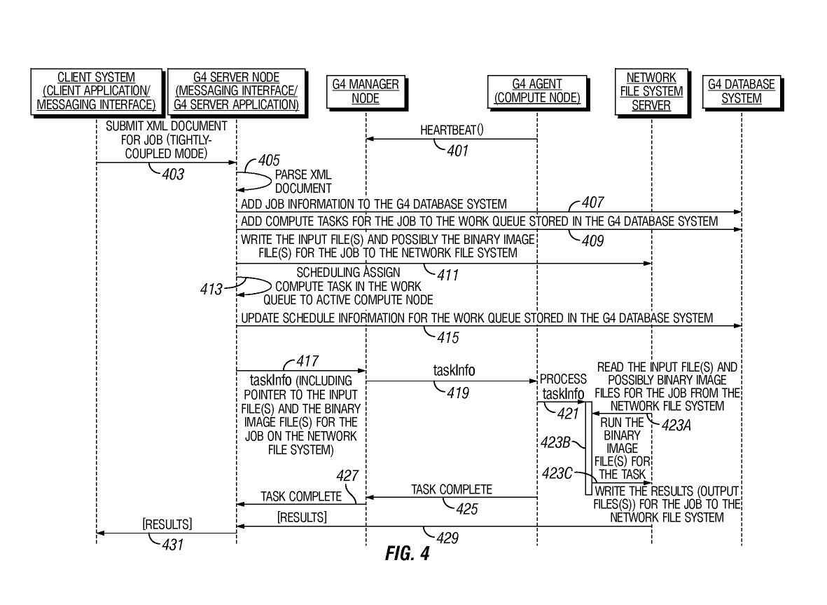

In order to carry out the operations of the tightly-coupled mode B, the XML document that specifies the job must specify a Collective where each and every Compute Node 112 of the Collective has access to a Network File System Server 110 that stores the job data. Details of Mode B are described below with respect to FIG. 4. It is assumed that the registration process for G4 Manager Node(s) and the Compute Nodes as described above with respect to steps 301 to 309 of FIG. 3 has been carried out.

The operations of FIG. 4 begin in step 401 where the G4 Agent Application 241 executing on the Compute Node sends the periodic heartbeat message to the appropriate G4 Manager Node 108.

In step 403, the Client Application 211 executing on the Client System 102 submits an XML document that specifies a job to the G4 Server Node 104 for execution in a tightly-coupled mode as described herein. Upon receipt of the XML document that specifies the job, the G4 Server Application 201 executing on the G4 Server Node 104 parses the XML document to generate information for the job in step 405 and cooperates with the G4 Database Application 221 executing on the G4 Database System 106 to store such job information on the G4 Database System 106 in step 407.

In step 409, the G4 Server Application 201 executing on the G4 Server Node 104 cooperates with the G4 Database Application 221 executing on the G4 Database System 106 to add the compute tasks of the job to a work queue stored on the G4 Database System 106.

In step 411, the G4 Server Application 201 executing on the G4 Server Node 104 stores the job data (e.g., the input data file(s) and the programs for the compute tasks of the job) to the directory of the Network File System Server 110 as specified in the XML document submitted in step 403.

In step 413, the G4 Server Application 201 executing on the G4 Server Node 104 performs a scheduling process that assigns compute tasks in the work queue stored on the G4 Database System 106 to the active Compute Nodes. This scheduling process assigns the compute tasks for the job to the active Compute Nodes that belong to the Collective specified for the job. In this case, each and every Compute Node 112 of the Collective has access to the directory of the Network File System Server 110 that stores the job data.

In step 415, the G4 Server Application 201 executing on the G4 Server Node 104 cooperates with the G4 Database Application 221 executing on the G4 Database System 106 to update schedule information (which indicates which active Compute Node has been assigned the given compute task) for the work queue stored on the G4 Database System 106.

In step 417, the G4 Server Application 201 executing on the G4 Server Node 104 generates and sends the “taskInfo” data for the compute task to the appropriate G4 Manager Node 108 associated with the active Compute Node to which the compute task had been assigned in step 413. In this case, the “taskInfo” data for the compute task includes pointers to the job data files stored in a directory of the Network File System Server 110 for the job. In step 419, the G4 Manager Node 108 forwards on the “taskInfo” data for the compute task to the active Compute Node to which the compute task had been assigned in step 413.

In step 421, the G4 Agent Application 241 executing on the given Compute Node receives and processes the “taskInfo” data for the compute task in order to initiate execution of the program of the compute task on the Compute Node, which occurs in step 423A, 423B and 423C. In step 423A, the G4 Agent Application 241 executing on the given Compute Node reads the input files and possibly the program file(s) for the compute task from the directory of the Network File System Server 110 that stores the job data (such data was written to this directory in step 411). In step 423B, the G4 Agent Application 241 executing on the given Compute Node initiates execution of the program file(s) for compute task. In step 423C, when the execution of the program of the compute task on the Compute Node is complete, the G4 Agent Application 241 executing on the Compute Node collects the results of such execution (i.e., the output files and/or any error codes, if any) and stored such results to the directory of the Network File System Server 110 that stores the job data.

The operation of the G4 Agent Application 241 of step 421 can involve variable substitution. In this case, the “taskInfo” data for the compute task as generated by the G4 Server Node 104 includes information that specifies a list of one or more variables that are to be substituted along with values for the substituted variable(s). The G4 Agent Application 241 reads a copy of the input file(s) for the compute task from the directory of the Network File System server 110 and utilizes the variable substitution information of the “taskInfo” data to carry out the variable substitution for the respective input file, which replaces the substituted variable(s) of the respective input file with the appropriate value(s) as specified by the “taskInfo” data and stores the updated input file for use in carrying out the compute task.

Upon completion of step 423C, the G4 Agent Application 241 executing on the Compute Node sends a “TaskComplete” message to the G4 Server Node 104 via the corresponding G4 Manager Node 108 in steps 425 and 427. In this case, the “TaskComplete” message communicated to the G4 Server Node 104 does not include the output file(s) of the compute task. Instead, upon receiving the “Task Complete” message, the G4 Server Application 201 executing on the G4 Server Node 104 accesses (copies) the results of the compute task from the directory of the Network File System Server 110 for the job in step 429. The G4 Server Application 201 executing on the G4 Server Node 104 can cooperate with the G4 Database Application 221 executing on the G4 Database System 106 to store the results of the compute task on the G4 Database System 106. In step 431, the G4 Server Application 201 executing on the G4 Server Node 104 can also forward such results to the Client Application that issued the job (step 403) as appropriate.

The periodic heartbeat messages of step 401 can also be communicated during execution of a compute task by the Compute Node. As described above, in the event that the appropriate G4 Manager Node 108 fails to receive the periodic “heartbeat” message from a given active Compute Node within a predetermined time period (which can be dictated by the “Timeout” parameter as specified in the “taskInfo” data for the compute task), the G4 Manager Application 231 can automatically remove the given Compute Node from its list of active Compute Nodes and sends a “Compute Node Inactive” message that identifies the inactive status of the corresponding Compute Node to the G4 Server 104. When the G4 Server Application 201 executing on the G4 Server Node 104 receives the “Compute Node Inactive” message from the G4 Manger Node 108, the G4 Server Application 201 can automatically remove the given Compute Node from its list of active Compute Nodes and also reset the execution status of any compute task that was being executed on the given Compute Node so that the G4 Server Application 201 can re-assign the compute task to another suitable Compute Node for execution thereon. Such heartbeat processing can be used to dynamically identify node failures or shutdowns during the execution of a compute task and allow the G4 Server Application 201 to re-assign the compute task to another suitable Compute Node for execution thereon.

Note that the XML document that specifies a job employs XML, which is a meta-language describing the structure of data. XML does not employ a fixed set of elements like HTML. Instead, XML is a general-purpose specification for creating custom markup languages. XML is classified as an extensible language because XML allows users to define their own elements. XML facilitates the sharing of structured data across different information systems, particularly via the Internet.

The XML document that specifies a job employs an XML schema, which is a model that describes the structure and constrains the contents of the XML document. The constraints defined for the XML document follows the basic syntax constraints imposed by XML. An XML schema provides a view of an XML document at a relatively high level of abstraction. There are languages developed specifically to express XML schemas. For example, the Document Type Definition (DTD) language, which is native to the XML specification, is a schema language that is of relatively limited capability, but has other uses in XML aside from the expression of schemas. Another very popular and more expressive XML schema language is XML Schema standardized by World Wide Web Consortium (W3C). The mechanism for associating an XML document with an XML schema varies according to the schema language. The process of checking to find out if an XML document conforms to an XML schema is called validation, which is typically carried out by an XML parsing engine. A large number of open-source XML parsing engines are available online and suitable for the present application.

In one embodiment, the XML document that specifies a job that is to be processed by the G4 HPC Environment can include one or more of the following elements.

The XML “root” element of the XML document that specifies a job is:

<job [attribute=“value”]>

or

<batch [attribute=“value”]>

The <job> element is used to specify the job for executing in the fully-distributed mode of operation (mode A) as described above. The <batch> element is used to specify the job for executing in the tightly-coupled mode of operation (mode B) as described above.

Valid attributes for both the <job> and the <batch elements include:

| | |
|---|---|
| author = “string”: | user (person or script) that created the particular |
| | XML document |
| comment = “string”: | description about the job |
| created = “date string”: | date/time that the particular XML document was created |
| expires = “delta time”: | how long the job will remain in the G4 HPC |
| | Environment before it is deleted (default is 1 week) |
| jobname = “string”: | name of job (defaults to Jobxxxx where xxxx is the |
| | jobid of the job) |
| jobtimeout = “seconds”: | job will be aborted if the job's elapsed time |
| | exceeds this value (defaults to 100 years) |
| tasktimeout = “seconds”: | abort any compute tasks that takes longer than |
| | specified value; compute tasks will be |
| | automatically re-executed unless the compute |
| | task's retrycount has been exceeded; |
| | (Default is 100 years) |
| retrycount = “number”: | if a compute task terminates with non-zero exit |
| | code, decrement retrycount, and while |
| | retrycount is >0, re-execute the task on |
| | another Compute Node (default = 2) |
| abortonerror = “true/false”: | abort job if any task terminates with non-zero exit |
| | status (default = false) |
| savework = “true/false”: | save “workarea” for compute tasks of the job to a |
| | ZIP file with label_WORKAREA_.xxxx |
| | (default is false) |
| maxtasks = “number”: | maximum number of compute tasks allowed for |
| | the job (default = 100000) |
| activetasks = “number”: | maximum number of simultaneous actives tasks |
| | allowed for the job (default = 100000) |
| cores = “number”: | minimum number of cores required by each task |
| | in the job (default = 1) |
| priority = “number”: | default priority for job, between 1 (lowest) and |
| | 255 (default = 100) |
| platform = “string”: | if packages exist for multiple platforms, use only |
| | specified platform(s) |
| | (default is “*” (any platform where ‘package’ |
| | exists)) |
| collectives = “string”: | list of one or more collectives to use for the job |
| | (default is “default”) |
| nodes = “string”: | list of FQDN Compute Nodes to use for the job; |
| | Note that either collectives or a specific list of |
| | Compute Nodes may be specified. |
| taskbundle = “number”: | this information is used in scheduling tasks for |
| | bundling a “number” of tasks together for |
| | execution on a particular Compute Node |
| after = “date string”: | start job after specified date/time is reached |
| shell = “string”: | valid only for <batch> element, this specifies the |
| | shell (csh, tcsh, etc) in which to execute the job |
| nfsDir = “indirect”: | valid only for <batch> element, this points to an |
| | NFS disk and directory specified in a server configuration |
| | file. |

The <job> element requires a single execute section, and one or more task sections. The <job> element and the <batch> element may also have one or more input, output, environment sections. All sections that are direct children of a respective <job> element or <batch> element are considered to be ‘global’ to the job/batch, and all tasks will use these definitions.

The execute element informs the G4 HPC Environment what “execution package” is to be used by all tasks in the job. It has form:

<execute [attributes=“value”]/>

Valid attributes of the execute element include:

| | |
|---|---|
| owner=“string”: | owner of the package (defaults to user submitting |
| | the XML document specifying the job) |
| application=“string”: | name of the application (must be specified) |
| program=“string”: | name of the program (required for pre-installed |
| | packages) |
| version=“date string”: | version of the owner/application/program. If not |
| | specified, the “default” version of the package |
| | is used. |
| command=“string”: | command string used to execute the code. |
| | (Usually defaults to program.exe) |
| args=“string”: | command line arguments to be appended to |
| | command. |
| memory=“number”: | recommended free memory (Mbytes) on the |
| | Compute Node for execution of the code. This is |
| | only a “hint”, and is not enforced. |
| | (default = 100). |

Note that if the application attribute is “BATCH”, the “shell” attribute is either “bash” (for Linux based platforms) or “cmd” for Windows based platforms. The tasks in BATCH jobs will be executed exclusively by the Compute Nodes of the Collective. In one embodiment, the Compute Nodes of the Collective can include either Linux or Windows platforms (but not a mix of both). In this case, the job will not use both Windows and Linux platforms to execute the tasks of the job for the tightly-coupled mode of operation.

BATCH jobs can also define a file to be used as STDIN, which should be either a bash script for Linux platforms, or a cmd script for Windows platforms.

Execution packages may also be pre-installed, such as:

```
<execute
  owner = “WebMI”
  application = “ModelingCodes”
  program  = “dc3d-ha”
/>
```

If the application attribute is “PRIVATE”, then the execute element contain at least one package child element, which defines the program package(s) to be used exclusively by this job as follows:

```
  <execute application=“PRIVATE”>
    <package name=“myCode.Linux-x86_64.zip”
    platform=“Linux-x86_64”
command=“myCode”/>
    <package name=“myCode.Windows-amd64.zip”
    platform=“Windows-amd64”
command=“myCode.exe”/>
  </execute>
```

The package element is valid only as a child of execute, and only if the execute attribute application is “PRIVATE”. An execution package is a platform specific ZIP file, containing the executable code for that platform, along with any static input files that the code may require. It has the form:

<package [attributes=“value”/>

Valid attributes for the package element include:

| | |
|---|---|
| name = “string”: | path to ZIP file containing executable code and |
| | other static input files |
| platform = “string”: | must be a platform known by the G4 |
| | HPC Environment, such as |
| | Linux-i686 |
| | Linux-ia64 |
| | Linux-x86_64 |
| | Windows-x86 |
| | Windows-amd64 |
| | Darwin-i386 |
| command = “string”: | command string used by Compute Node to |
| | execute\code |
| args = “string”: | command line arguments to be appended to |
| | command |
| memory = “number”: | recommended free memory (Mbytes) on the |
| | Compute Node for execution of the code; this is |
| | only a “hint”, and is not enforced (default = 100) |
| properties = “string” | specific properties of this code, e.g.: “GPU” |

The output element defines an output file written by the job's tasks that is to be returned to the requestor. If output is a child of job, then the file is expected to be written by all tasks; if output is a child of task, then the file specific to that task.

<output [attributes=“value”]/>

Valid attributes for the output element include:

| | |
|---|---|
| name = “string”: | name of output file to be returned to requestor |
| type = “string”: | all output files are assumed to be text files, |
| | unless “binary” or “ZIP” is specified |
| save = “string”: | one of: “always”, “never”, “onerror”; the output file |
| | is always saved, never saved, or saved only if the task |
| | exits with non-zero exit status. (default is “always”) |
| head = “number”: | save only beginning “number” of bytes of file |
| tail = “number”: | save only last “number” of bytes of file |
| internal = | file will be save as an internal file (default is “false”) |
| “true/false”: | |
| stdout = | file will be task's STDOUT stream (default is “false”) |
| “true/false” | |
| extract = “string” | list of file to extract from archive if the type is “ZIP” |

If neither head nor tail is specified, the whole file is saved; otherwise either head or tail may be specified. In one embodiment, the maximum combined size of all internal files per task must be less than one megabyte. If the type of output file is “ZIP” and if the G4 Client Application is the G4 command-line utility, it will automatically extract the list of files specified in “extract” attribute once the archive has been downloaded to the G4 Client Application.

The input element defines an input file that is to be used by the job's tasks.

If input is a child of job, then the file will to be used by all tasks; if input is a child of task, then the file specific to that task. It has the form:

<input [attributes=“value”]/>

Valid attributes for the input element include:

| | |
|---|---|
| name = “string”: | name of input file supplied by the requestor for |
| | the job. |
| type = “string”: | all input files are assumed to be text files, |
| | unless “binary”, “zip”, or “executable” is |
| | specified; Both “zip” and “executable” imply |
| | “binary” (default is “text”) |
| as = “string”: | write the file on the G4 agent application using the |
| | specified name |
| stdin = | The file will be used as the task's STDIN stream |
| “true/false”: | (default = “false”) |
| extract = “string”: | list of file to extract from archive if the type is “ZIP” |

The substitute element must be a child of input (or stdin). The substitute element is used to replace strings in the input file with alternate values. It has the form:

<substitute [attributes=“value”]/>

Valid attributes of the substitute element include:

string=“value” original string

with =“value” new string

An example of the substitute element follows:

<input name=“myInput.dat”>
<substitute string=“${oldValue}” with=“newValue” />
</input>

In this case, in each task, where the file “myInput” is specified, it will be edited (by the G4 Agent Application executing on the Compute Node) and occurrences of the variable ${oldValue} will be replaced with the actual values, in this example—“newValue.”

The environment element is used to define an environment variable for the task. If environment is a child of job, then the variable will to be set for all tasks in the job; if environment is a child of task, then the variable will be set only for that specific task. It has the form:

<environment [attributes=“value”]/>

Valid attributes for the environment element include:

| | |
|---|---|
| set = “string”: | name of the environment variable to be set |
| value = | value of the environment value |
| “string”: | |
| os = “string”: | one of: “Linux”, “Windows”, “Both” (default is “both”) |

Examples of the environment element include:

<environment set=“DEBUG_LEVEL” value=“2”/>
<environment set=“scratchFile” value=“/tmp/scratch” os=“Linux”/>
<environment set=“scratchFile” value=“d:\temp\scratch” os=“Windows”/>

The task element is used to define the job's tasks. At least one task needs to be defined in each job. It has the form:

<task [attributes=“value”]/>

Valid attributes for the task element include:

| | |
|---|---|
| tag = “number”: | The task's identifier (default = 1) (auto- |
| | incremented) |
| arglist = “string”: | The task's command line arguments |
| timelimit = “number”: | The maximum elapsed (wall clock) time in |
| | seconds for the task (default = unlimited) |
| memory = “number”: | recommended free memory (Mbytes) on the |
| | Compute Node for execution of the task.; this is |
| | only a “hint”, and is not enforced (default = 100) |

The G4 HPC Environment 100 as described herein is particularly suited to perform distributing computed processing for log modeling and inversion of tool responses in support of workflows within the oil and gas industry. Such workflows include, but are not limited to the following:
reservoir characterization, which is performed to obtain better estimates of true formation properties in vertical and deviated wells;
formation evaluation of reservoir properties distribution and reservoir geometry in high angle and horizontal wells;
delineation of reservoir geometry while drilling and real-time geo-steering decision making during the well placement operation;
pre-job modeling and inversion for well placement to evaluate optimal measurement configuration; and
interpretation of deep reading measurements such as cross-well, surface-to-borehole, magneto-telluric and control-source electromagnetics.

One of the key factors that have prevented widespread commercial adoption of modeling and inversion codes is computational performance. With the code running on an individual workstation, even if it is multicore, modeling may still take hours, and some commercial inversion job may take days to weeks to complete.

However, well-logging modeling and inversion problems respond well to parallelization, since each logging point is computed independently of the others. Thus, the G4 HPC Environment 100 as described herein can be used to implement an infrastructure of ubiquitously available log modeling and inversion services that are executed on high-performance computing systems.

For reservoir modeling and simulation applications, the substitute element of the XML document as described above can be used in conjunction with one input file to specify a number of tool positions that are to be written as part of the one input file for distributed processing on the Compute Nodes of the G4 HPC Environment 100. In this case, the common input file is sent to each Compute Node that is used to process the compute tasks of the job. However, the G4 Agent Application, before giving it to the program of the task, reads it in and makes the variable substitution (replaces it (or them) to the real value(s)). Thus, the actual input data for every task is again different. This variable substitution is advantageous for many reservoir modeling and simulation applications which use as an input some sort of file (let's call it “control”) that specifies the interval where the simulation is to be performed. Typically, this is either a well trajectory or, probably more commonly, just a start and stop tool positions (depths) and an interval between two consequent tool positions. In this scenario, the location of the intervals, such as the start and stop tool positions of the intervals, can be specified by variable substitution. This allows the same common input file to be used for some or all of the compute tasks with dynamic variable substitution specifying the interval position for each respective compute task.

As used herein, a “document” is a self-contained collection of information created by execution of a computer program. The document can be given a filename or other handle by which it can be accessed. The document can be human readable and/or machine readable. In various embodiments, the structured document that specifies a given job is an XML document. XML is convenient because there is a significant infrastructure available for processing this type of structured text file, such as parsers (both DOM and SAX), and translators (XSLT), etc. This makes working with the XML document easier and opens up for interoperability with other applications. Other types of structured text documents with similar properties can also be used to specify a given job. For example, JavaScript Object Notation (JSON) documents or YAML documents can be used. JSON is very popular today in the open source community.

Although several example embodiments have been described in detail above, those skilled in the art will readily appreciate that many modifications are possible in the example embodiments without materially departing from the scope of this disclosure. Accordingly, all such modifications are intended to be included within the scope of this disclosure.

1. A distributed computing system for use with a plurality of client systems, the distributed computing system comprising:
a server node;
a plurality of compute nodes; and
a network file system server providing shared data storage resources;
wherein said server node is configured to receive and process a document submitted by one of said plurality of client systems, wherein said document specifies a job including a number of compute tasks that are to be executed in a distributed manner by said plurality of compute nodes, data for at least one compute task of the job, a shared directory on said network file system server, and a first collection of said compute nodes that have access to said shared directory;
wherein said server node is further configured to store the data for the at least one compute task of the job into said shared directory; and
wherein at least one compute node that belongs to said first collection of compute nodes is configured to access said shared directory to process the data for the at least one compute task of the job for execution of the at least one compute task.

2. A distributed computing system according to claim 1, wherein:
said server node is configured to maintain a list of active compute nodes and to schedule the compute tasks of the job as specified by the document on active compute nodes that belong to said first collection of compute nodes.

3. A distributed computer processing system according to claim 1, wherein:
the data for the at least one compute task of the job as specified by said document comprises at least one input file.

4. A distributed computer processing system according to claim 3, wherein:
the at least one input file refers to at least one variable that is substituted dynamically at run time by operation of at least one compute node that belongs to said first collection of compute nodes.

5. A distributed computer processing system according to claim 1, wherein:
the data for the at least one compute task of the job as specified by said document comprises a program to be executed as part of the compute task.

6. A distrusted computer processing system according to claim 1, wherein:
at least one compute node that belongs to said first collection of compute nodes is configured to access said shared directory to store results of execution of the compute tasks of the job; and
said server node accesses said shared data in order to return the results of execution of the compute tasks for the job to the one client system that submitted said document that specified the job.

7. A distributed computer processing system according to claim 6, wherein:
the results of execution of the compute tasks of the job comprises at least one output file.

8. A distributed computer processing system according to claim 6, wherein:
the results of execution of the compute tasks of the job comprises an error code or error message.

9. A distributed computer processing system according to claim 1, wherein:
said plurality of compute nodes are heterogeneous in nature with different computer processing platforms.

10. A distributed computer processing system according to claim 1, wherein: said plurality of compute nodes are heterogeneous in nature with a second collection of compute nodes that do not have access to the shared data storage resources of said network file server system.

11. A distributed computer processing system according to claim 1, wherein:
said document includes a first element that identifies the job as a type involving the shared data storage resources of a network file system server; and
said server node processes said first element of said document in order to configure operations of said server node and said first collective of compute nodes for execution of the compute tasks of said job.

12. A distributed computer processing system according to claim 11, wherein:
said server node is configured to receive and process other documents submitted by said plurality of client systems, wherein each respective other document specifies a job including a number of compute tasks that are to be executed in a distributed manner by said plurality of compute nodes, wherein the respective other document includes a second element that identifies the job as a type involving local data storage resources on said plurality of compute nodes; and
said server node processes said second element of the respective other document in order to configure operations of said server node and the plurality of compute nodes for execution of the compute tasks of the job.

13. A distributed computing system according to claim 1, wherein:
said document comprises an XML document.

14. A distributed computing system according to claim 1, further comprising:
at least one manager node operably coupled between said server node and a number of compute nodes associated therewith, wherein said at least one manager node monitors operational status of the number of compute nodes associated therewith and relays messages between said server node and the number of compute nodes associated therewith.

15. A distributed computing system according to claim 1, further comprising:
a database management system operably coupled to said server node, wherein said database management system is configured to store information pertaining to the compute nodes of the system as well as information pertaining to the jobs executed by the compute nodes of the system.

16. A distributed computing system according to claim 1, wherein:
said client system comprises a client application that operates to generate the document specifying the job.

17. A distributed computing system according to claim 16, wherein:
said client system and said server node include messaging interfaces that allow for communication of messages therebetween.

18. A distributed computing system according to claim 17, wherein:
said messaging interface employ a standardized messaging protocol.

19. A distributed computing system according to claim 1, wherein:
at least said server node is located remotely with respect to said client system.

20. A distributed computing system according to claim 1, wherein:
said plurality of compute nodes are located remotely with respect to said client system.

21. A distributed computing system according to claim 1, wherein:
the compute tasks of the job specified by the document carry out well-log modeling and inversion of geophysical well logging tool responses in support of an oil and gas industry workflow.

22. A method of executing a job on a distributed computing system including a server node, a plurality of compute nodes, a network file system server providing shared data storage resources, and a plurality of client systems, the method comprising:
operating the server node to receive and process a document submitted by one of said plurality of client systems, wherein said document specifies a job including a number of compute tasks that are to be executed in a distributed manner by said plurality of compute nodes, data for at least one compute task of the job, a shared directory on said network file system server, and a first collection of said compute nodes that have access to said shared directory;
in response to processing the document, operating the server node to store the data for the at least one compute task of the job into said shared directory; and
in response to processing the document, operating at least one compute node that belongs to said first collection of compute nodes to access said shared directory to process the data for the at least one compute task of the job for execution of the at least one compute task.

23. A method according to claim 22, further comprising:
operating said server node to maintain a list of active compute nodes and to schedule the compute tasks of the job as specified by the document on active compute nodes that belong to said first collection of compute nodes.

24. A method according to claim 22, wherein:
the data for the at least one compute task of the job as specified by said document comprises at least one input file.

25. A method according to claim 24, wherein:
the at least one input file refers to at least one variable that is substituted dynamically at run time by operation of at least one compute node that belongs to said first collection of compute nodes.

26. A method according to claim 22, wherein:
the data for the at least one compute task of the job as specified by said document comprises a program to be executed as part of the compute task.

27. A method according to claim 22, further comprising:
operating at least one compute node that belongs to said first collection of compute nodes to access said shared directory to store results of execution of the compute tasks of the job; and
operating said server node to access said shared data in order to return the results of execution of the compute tasks for the job to the one client system that submitted said document that specified the job.

28. A method according to claim 22, wherein:
the results of execution of the compute tasks of the job comprises at least one output file.

29. A method according to claim 27, wherein:
the results of execution of the compute tasks of the job comprises an error code or error message.

30. A method according to claim 11, wherein:
said document includes a first element that identifies the job as a type involving the shared data storage resources of a network file system server; and
said server node processes said first element of said document in order to configure operations of said server node and said first collective of compute nodes for execution of the compute tasks of said job.

31. A method according to claim 30, further comprising:
operating said server node to receive and process other documents submitted by said plurality of client systems, wherein each respective other document specifies a job including a number of compute tasks that are to be executed in a distributed manner by said plurality of compute nodes, wherein the respective other document includes a second element that identifies the job as a type involving local data storage resources on said plurality of compute nodes;
wherein said server node processes said second element of the respective other document in order to configure operations of said server node and the plurality of compute nodes for execution of the compute tasks of the job.

32. A method according to claim 22, wherein:
the compute tasks of the job specified by the document carry out well-log modeling and inversion of geophysical well logging tool responses in support of an oil and gas industry workflow.
